(19) United States
(12) Patent Application Publication
(10) Pub. No.: US 2007/0096624 A1
(43) Pub. Date: May 3, 2007

(54) Electron emission device

(76) Inventors: Sang-Jo Lee, Suwon-si (KR); Chun-Gyoo Lee, Suwon-si (KR); Sang-Ho Jeon, Suwon-si (KR); Sang-Hyuck Ahn, Suwon-si (KR); Su-Bong Hong, Suwon-si (KR); Jong-Hoon Shin, Suwon-si (KR)

Correspondence Address: Robert E. Bushnell;Suite 300, 1522 K Street, N.W., Washington, DC, 20005, US

(21) Appl. No.: 11/583,047

(22) Filed: Oct. 19, 2006

(30) Foreign Application Priority Data
Oct. 31, 2005 (KR) 10-2005-0103513

(51) Int. Cl. H01J 63/04; H01J 1/62

(52) U.S. Cl. 313/496

(57) ABSTRACT

An electron emission device is provided. The electron emission device includes first and second substrates facing each other, a cathode electrode arranged on the first substrate, at least one opening electron emission region arranged on the cathode electrode, an insulation layer arranged on the cathode electrode and provided with at least one opening corresponding to the at least one opening electron emission region, and a gate electrode arranged on the insulation layer and provided with at least one opening corresponding to the at least one electron emission region. A width H1 of the at least one opening of the insulation layer is equal to or greater than twice a thickness T1 of the insulation layer.

### CLAIM OF PRIORITY

This application makes reference to, incorporates the same herein, and claims all benefits accruing under 35 U.S.C. §119 from an application for ELECTRON EMISSION DEVICE earlier filed in the Korean Intellectual Property Office on the 31 Oct. 2005 and there duly assigned Serial No. 10-2005-0103513.

### BACKGROUND OF THE INVENTION

1. Field of the Invention

The present invention relates to an electron emission device having improved electron emission efficiency.

2. Description of the Related Art

Generally, electron emission devices are classified into those using hot cathodes as an electron emission source, and those using cold cathodes as the electron emission source.

There are several types of cold cathode electron emission elements, including Field Emitter Array (FEA) elements, Surface Conduction Emitter (SCE) elements, Metal-Insulator-Metal (MIM) elements, and Metal-Insulator-Semiconductor (MIS) elements.

The FEA electron emission device uses a theory in which, when a material having a relatively lower work function or a relatively large aspect ratio is used as the electron source, electrons are effectively emitted by an electric field in a vacuum atmosphere. Recently, electron emission regions formed of a carbon-based material such as carbon nanotubes, graphite, and diamond-like carbon has been developed.

A typical FEA electron emission device includes a vacuum envelope having first and second substrates facing each other. Electron emission regions and cathode and gate electrodes that are driving electrodes for controlling the electron emission of the electron emission regions are formed on the first substrate. A phosphor layer and an anode electrode for effectively accelerating the electrons emitted from the first substrate toward the phosphor layer are provided on the second substrate. With this structure, the FEA electron emission device emits light or displays an image.

In the FEA electron emission device, the gate electrode is formed above the cathode electrode with an insulation layer interposed therebetween. Openings are formed in the gate electrode and the insulation layer at each crossed region of the cathode electrode and the gate electrode. The electron emission regions are generally formed on the cathode electrode in the openings.

The electron emission regions can be formed through a screen-printing process that is simple and effective in manufacturing a large-sized device. In order for the gate electrode to have a sufficient height with respect to the electron emission regions, the insulation layer is formed through a thick film process, such as a screen-printing process, a doctor-blade process, or a laminating process.

When the crossed region of the gate and cathode electrodes is defined as a pixel region, it is preferable to finely form the openings in the gate electrode and the insulation layer in order to enhance the uniformity of the electron emission in the pixel.

However, when a width of each opening formed in the gate electrode and insulation is too small, it is difficult to form the electron emission region having a sufficient area and thus, the electron emission efficiency is reduced.

### SUMMARY OF THE INVENTION

The present invention provides an electron emission device having enhanced electron emission uniformity and improved electron emission efficiency.

In an exemplary embodiment of the present invention, an electron emission device includes: first and second substrates facing each other; a cathode electrode arranged on the first substrate; at least one electron emission region arranged on the cathode electrode; an insulation layer arranged on the cathode electrode and having at least one opening corresponding to the at least one electron emission region; and a gate electrode arranged on the insulation layer and having at least one opening corresponding to the at least one electron emission region; a width H1 of the at least one opening of the insulation layer is equal to or greater than twice a thickness T1 of the insulation layer.

A width H2 of the at least one electron emission region with respect to the width H1 of the at least one opening of the insulation layer may be set to satisfy the following inequality:
0.2≦H2/H1≦1.

A thickness T2 of the at least one electron emission region may be set to satisfy the following inequality:
0.1≦T2/T1≦1.

The at least one electron emission region may include a material selected from a group consisting of carbon nanotubes, graphite, graphite nanofibers, diamonds, diamond-like carbon, fullerene C₆₀, silicon nanowires, and a combination thereof.

The electron emission device may further include a phosphor layer arranged on the second substrate and an anode electrode arranged on a surface of the phosphor layer.

The electron emission device may further include a focusing electrode arranged on the gate electrode but electrically insulated from the gate electrode.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial exploded perspective view of an electron emission device according to an embodiment of the present invention;

FIG. 2 is a partial sectional view of the electron emission device of FIG. 1;

FIG. 3 is a partial top view of the electron emission device of FIG. 1; and

FIG. 4 is a partial sectional view of an electron emission device according to another embodiment of the present invention.

### DETAILED DESCRIPTION OF INVENTION

The present invention is described more fully below with reference to the accompanying drawings, in which exemplary embodiments of the present invention are shown. The present invention can, however, be embodied in many different forms and should not be construed as being limited to the embodiments set forth herein; rather these embodiments are provided so that this disclosure will be thorough and complete, and will fully convey the concept of the present invention to those skilled in the art. Wherever possible, the same reference numbers are used throughout the drawings to refer to the same or like parts.

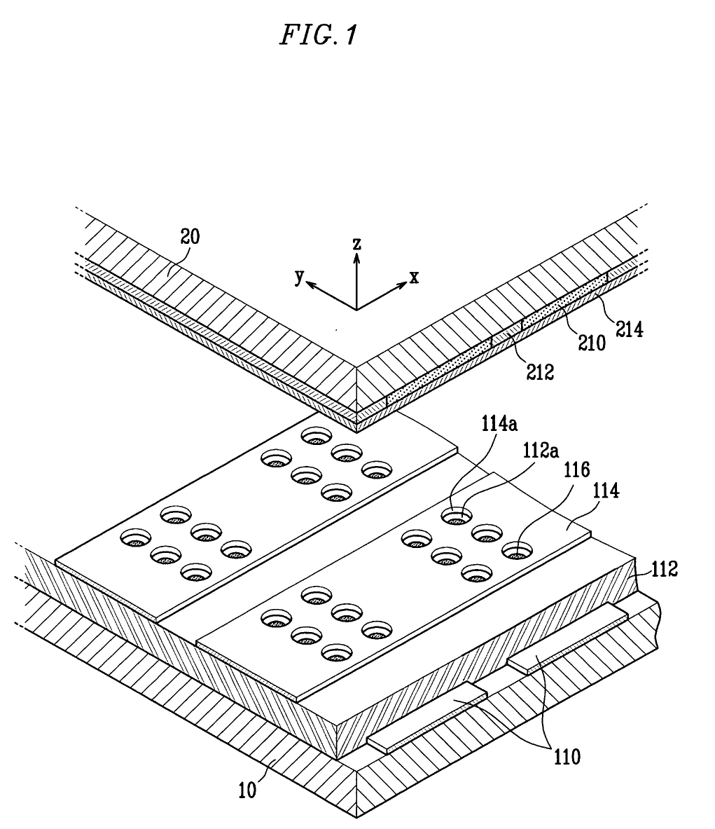

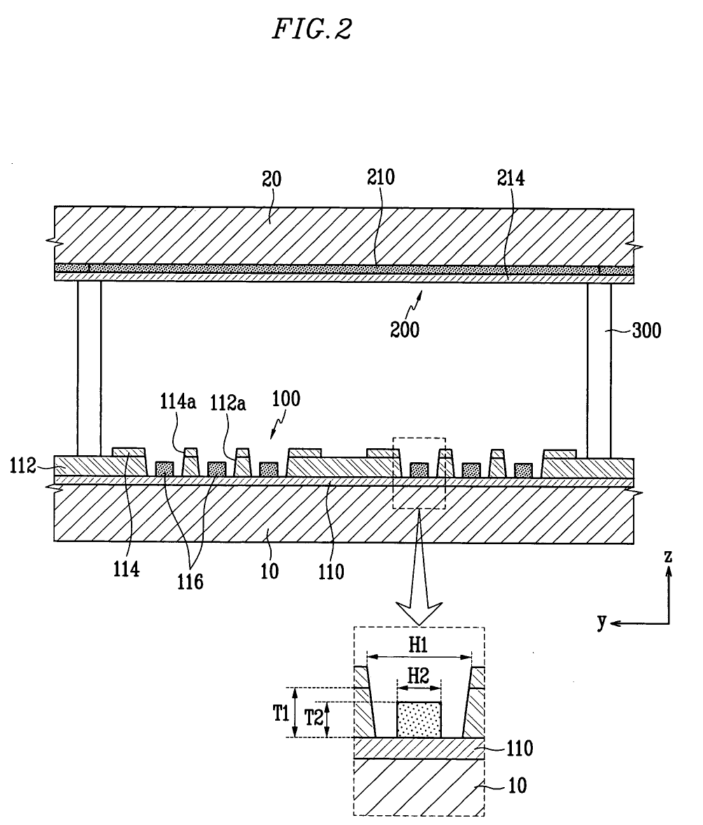

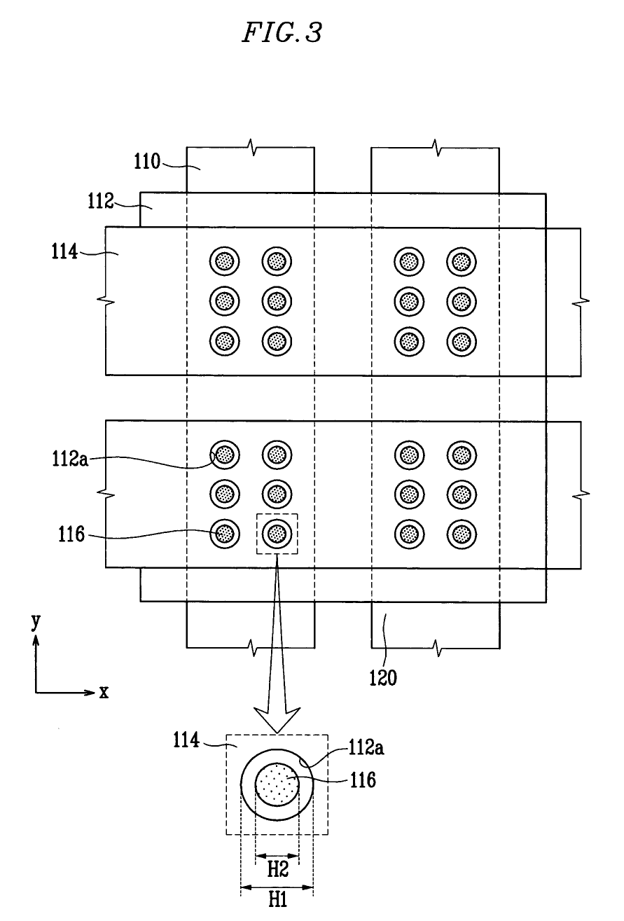

FIGS. 1, 2 and 3 are respectively partial exploded perspective, partial sectional, partial top views of an electron emission device according to an embodiment of the present invention.

Referring to FIGS. 1, 2 and 3, an electron emission device according to an embodiment of the present invention includes first and second substrates 10 and 20 facing each other and spaced apart from each other by a predetermined distance. A sealing member is provided at the peripheries of the first and the second substrates 10 and 20 to seal them together. Therefore, the first and second substrates 10 and 20 and the sealing member form a vacuum envelope.

An electron emission unit 100 for emitting electrons toward the second substrate 20 is provided on a surface of the first substrate 10 facing the second substrate 20 and a light emission unit 200 for emitting visible light by being excited by the emitted electrons is provided on a surface of the second substrate 20 facing the first substrate 10.

Describing the electron emission device in more detail, cathode electrodes 110 are formed in a stripe pattern extending in a direction (along a Y-axis in FIG. 1) and an insulation layer 112 is formed on the first substrate 2 to fully cover the cathode electrodes 110. Gate electrodes 114 are formed on the insulation layer 112 in a strip pattern running in a direction (along an X-axis in FIG. 1) to cross the cathode electrodes 110 at right angles.

Crossed regions of the cathode electrodes 110 and the gate electrodes 114 define pixel regions. Electron emission regions 116 are formed on the cathode electrodes 110 at each pixel region. Openings 112a and 114a corresponding to the respective electron emission regions 116 are formed in the insulation layer 112 and the gate electrodes 114 to expose the electron emission regions 116.

The insulation layer 112 is formed through a thick film process, such as a screen-printing process, a doctor blade process, or a laminating process.

A width H1 of the opening 112a formed in the insulation layer 112 and a thickness T1 of the insulation layer 112 satisfy the following Inequality 1.

Inequality 1:
H1≧2×T1

When a width of the opening 112a of the insulation layer 112 is equal to or greater than twice the thickness of the insulation layer 112 as described above, the area for disposing the electron emission region 116 in the opening 112a is sufficient and thus, the emission efficiency can be enhanced.

At this point, the opening 112a of the insulation layer 112 can be formed by wet-etching the insulation layer 112.

In addition, a width H2 of the electron emission region 116 is formed to satisfy the following Inequality 2 with respect to the width H1 of the opening 112a of the insulation layer 112 so that a short circuit does not occur between the gate and cathode electrodes 114 and 110 by the electron emission region 116 when the electron emission region 116 is disposed as close as possible to the gate electrode 114.

Inequality 2:
0.2≦H2/H1≦1.0

When the width H2 of the electron emission region 116 is too small as compared to the width H1 of the opening 112a of the insulation layer 112, an electric field formed by the gate electrode 114 and supplied to the electron emission region 116 is weakened and thus, the driving voltage must increase. When the width H2 of the electron emission region 116 is too large as compared to the width H1 of the opening 112a of the insulation layer 112, the electron emission region 116 may contact the gate electrode 114.

In addition, a thickness T2 of the electron emission region 116 is formed to satisfy the following Inequality 3 with respect to the thickness of the insulation layer 112 so that the beam diffusion of the electrons emitted from the electron emission region 116 is minimized and so that the electron emission uniformity in the pixel region is enhanced.

Inequality 3:
0.1≦T2/T1≦1.0

When the thickness T2 of the electron emission region 116 is too large as compared to the thickness T1 of the insulation layer 112, there is advantage of lowering the driving voltage but electrons may be emitted from the electron emission region 116 of a pixel that must be turned off by the anode electric field caused by a high voltage supplied to an anode electrode 214 that will be described later. When the thickness T2 of the electron emission region 116 is too small as compared to the thickness T1 of the insulation layer 112, the driving voltage is increased.

The electron emission regions 116 are formed of a material that emits electrons when an electric field is supplied thereto in a vacuum atmosphere, such as a carbonaceous material or a nanometer-sized material. For example, the electron emission regions 116 can be formed of carbon nanotubes, graphite, graphite nanofibers, diamonds, diamond-like carbon, fullerene C₆₀, silicon nanowires, or a combination thereof. The electron emission regions 116 can be formed through a screen-printing process, a direct growth, a chemical vapor deposition, or a sputtering process.

In the drawings, an example where six electron emission regions 116 are formed at each pixel region and plane shapes of the electron emission regions 116 and the openings 112a and 114a formed in the insulation layer 112 and the gate electrode 114 are circular is illustrated. However, the present invention is not limited to this example. That is, the number and shape of the electron emission regions 116 and the shapes of the openings 112a and 114a can be variously designed.

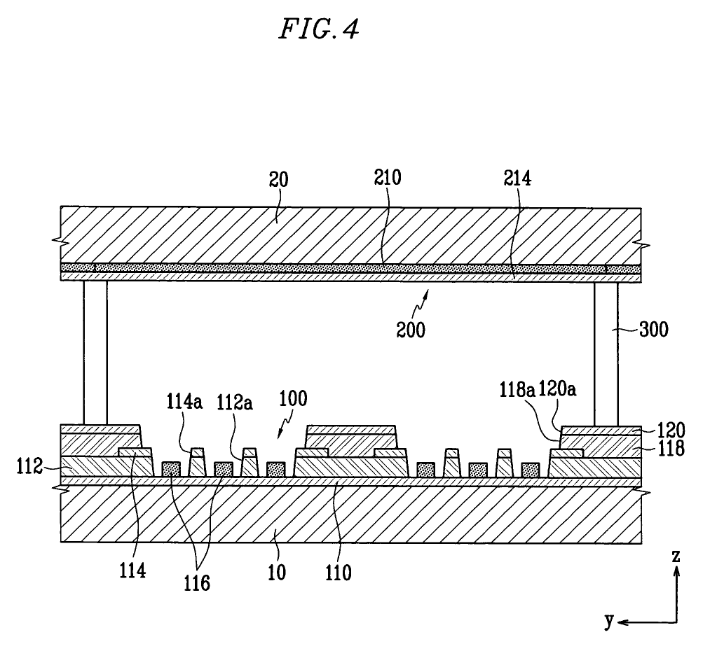

In addition, as shown in FIG. 4, a second insulation layer 118 and a focusing electrode 120 can be formed above the gate electrodes 114. In this case, openings 181a and 120a are formed in the second insulation layer 118 and the focusing electrode 120 to expose the electron emission regions 116. The openings 181a and 120a are formed to correspond to the respectively pixel regions to generally converge the electrons emitted from one pixel region. Since the focusing effect is enhanced as a height difference between the focusing electrode 12 and the electron emission region 116 increases, it is preferable that a thickness of the second insulation layer 118 is greater than that of the first insulation layer 112.

The focusing electrode 120 can be formed on an entire surface of the first substrate 10.

In addition, the focusing electrode 120 can be a conductive layer coated on the second insulation layer 118 or a metal plate provided with the openings 120a.

Phosphor and black layers 210 and 212 are formed on a surface of the second substrate 20 facing the first substrate 10 and an anode electrode 214 that is a metal layer formed of aluminum, for example, is formed on the phosphor and black layers 210 and 212. The anode electrode 214 functions to heighten the screen luminance by receiving a high voltage required for accelerating the electron beams and reflecting the visible light rays radiated from the phosphor layers 210 to the first substrate 10 toward the second substrate 20.

The anode electrode can be a transparent conductive layer formed of Indium Tin Oxide (ITO), for example, rather than the metal layer. In this case, the anode electrode is formed on surfaces of the phosphor and black layers, which face the second substrate 20.

Both an anode electrode formed of a transparent material and a metal layer for enhancing the luminance using the reflective effect can be formed on the second substrate.

The phosphor layers 210 can be formed to correspond to the respective pixel regions defined on the first substrate 10 or formed in a strip pattern extending in a vertical direction (the y-axis of FIG. 4) of the screen.

Disposed between the first and second substrates 10 and 20 are spacers 300 for uniformly maintaining a gap between the first and second substrates 10 and 20 against external forces. The spacers 32 can be arranged at a non-light emission region where the black layer 212 is formed so as not to interfere with the light emission of the phosphor layers 210.

The above-described electron emission display 100 is driven when predetermined voltages are supplied to the anode, cathode and gate electrodes 214, 110 and 114. For example, hundreds through thousands of volts are supplied to the anode electrode 214, a scan signal voltage is supplied to one of the cathode and gate electrodes 110 and 114, and a data signal voltage is supplied to the other of the cathode and gate electrodes 110 and 114.

Then, electric fields are formed around the electron emission regions 116 at pixels where a voltage difference between the cathode and gate electrodes 110 and 114 is above a threshold value and thus, the electrons are emitted from the electron emission regions 116. The emitted electrons collide with the phosphor layers 212 of the corresponding pixels by being attracted by the high voltage supplied to the anode electrode 214, thereby exciting the phosphor layers 212.

During the above-described operation of the electron emission device of the present embodiment, since the distance between the gate electrode 114 and the electron emission region 116 is reduced and the area of the electron emission region 116 increases, the emission efficiency is improved. That is, when the distance between the gate electrode 114 and the electron emission region 116 is reduced, the intensity of the electric field formed around the electron emission region 116 is enhanced. In addition, when the area of the electron emission region 116 is enlarged, the area of the edge where the electric field is concentrated is also enlarged. Therefore, by the enhanced electric field and the enlarged area of the edge of the electron emission region 116, the amount of electrons emitted by the electron emission region 116 increases.

In addition, even when the width H1 of the opening 112a of the insulation layer 112 is large relative to the thickness T1 of the insulation layer 112, since the thickness T2 of the electron emission region 116 is within a proper range with respect to the thickness T1 of the insulation layer 112, the electron emission uniformity in the pixel region is enhanced.

As described above, the electron emission device of the present invention can enhance the electron emission uniformity and improve the electron emission efficiency.

Therefore, the screen luminance of the electron emission device can be enhanced and the light emission and display qualities can be improved. In addition, the driving voltage can be lowered and thus the power consumption can be reduced.

Although exemplary embodiments of the present invention have been described in detail hereinabove, it should be clearly understood that many variations and/or modifications of the basic inventive concept taught herein still fall within the spirit and scope of the present invention, as defined by the appended claims.

What is claimed is:

1. An electron emission device, comprising:
first and second substrates facing each other;
a cathode electrode arranged on the first substrate;
at least one electron emission region arranged on the cathode electrode;
an insulation layer arranged on the cathode electrode and having at least one opening corresponding to the at least one electron emission region; and
a gate electrode arranged on the insulation layer and having at least one opening corresponding to the at least one electron emission region;
wherein a width H1 of the at least one opening of the insulation layer is equal to or greater than twice a thickness T1 of the insulation layer.

2. The electron emission device of claim 1, wherein a width H2 of the at least one electron emission region with respect to the width H1 of the at least one opening of the insulation layer satisfies the following inequality:
0.2≦H2/H1≦1.0

3. The electron emission device of claim 1, wherein a thickness T2 of the at least one electron emission region with respect to the thickness T1 of the insulation layer satisfies the following inequality:
0.1≦T2/T1≦1.0

4. The electron emission device of claim 2, wherein a thickness T2 of the at least one electron emission region with respect to the thickness T1 of the insulation layer satisfies the following inequality:
0.1≦T2/T1≦1.0

5. The electron emission device of claim 1, wherein the at least one electron emission region comprises a material selected from a group consisting of carbon nanotubes, graphite, graphite nanofibers, diamonds, diamond-like carbon, fullerene C₆₀, silicon nanowires, and a combination thereof.

6. The electron emission device of claim 1, further comprising:
a phosphor layer arranged on the second substrate; and
an anode electrode arranged on a surface of the phosphor layer.

7. The electron emission device of claim 1, further comprising a focusing electrode arranged on the gate electrode but electrically insulated from the gate electrode.
